(19) United States
(12) Patent Application Publication
(10) Pub. No.: US 2012/0203498 A1
(43) Pub. Date: Aug. 9, 2012

(54) TAMPER DETECTION WITH TILT SENSORS

(75) Inventors: Scott Gerald Fleischman, Palmetto, FL (US); Joseph Christopher Hart, Palm Harbor, FL (US)

(73) Assignee: HONEYWELL INTERNATIONAL INC., Morristown, NJ (US)

(21) Appl. No.: 13/020,316

(22) Filed: Feb. 3, 2011

(51) Int. Cl. G06F 15/00

(52) U.S. Cl. 702/150

(57) ABSTRACT

A reference relative orientation between a first component and a second component of a package is determined based on signals generated by a first tilt sensor mounted on the first component of a package and a second tilt sensor mounted on a second component of the package. After determining the reference relative orientation, tampering with the first or second components of the package can be detected by at least determining whether the orientation of the first and second components have changed relative to each other based on the reference relative orientation and signals generated by the first and second tilt sensors.

### TECHNICAL FIELD

The present disclosure relates to determining if one or more components of a package have moved with respect to another component.

### BACKGROUND

Packages, such as electronic packages, may contain components that are of a sensitive nature. For example, an electronics component may comprise circuitry that the manufacturer or a customer would like to prevent from being inspected by unauthorized parties.

### SUMMARY

In general, the disclosure is directed to determining if one component of a package has changed orientation with respect to one or more other components of the package. The orientation of the components relative to each other may indicate, for example, whether the package or its components have been tampered with. In some examples, tilt sensors are used to determine the relative orientation of at least two components of a package, and the output of the tilt sensors can be used to detect a change in the relative orientation of the components.

In one example, the disclosure is directed to a method comprising determining with a processor a reference relative orientation between a first component and a second component based on signals generated by a first tilt sensor mounted on the first component and a second tilt sensor mounted on a second component, and after determining the reference relative orientation, determining with the processor whether an orientation of the first and second components have changed relative to each other based on the reference relative orientation and signals generated by the first and second tilt sensors.

In another example, the disclosure is directed to a system comprising a first component and a second component, a first tilt sensor that generates a signal indicative of an orientation of the first component, a second tilt sensor that generates a signal indicative of an orientation of the second component, and a processor configured to determine a reference relative orientation between the first component and the second component based on signals generated by the first tilt sensor and the second tilt sensor, and after determining the reference relative orientation, determine whether the orientation of the first and second components have changed relative to each other based on the reference relative orientation and signals generated by the first and second tilt sensors.

In another example, the disclosure is directed to a system comprising a first component and a second component, a means for determining an orientation of the first component, the means for determining an orientation of the first component generating a signal indicative of an orientation of the first component, a means for determining an orientation of the second component, the means for determining an orientation of the second component generating a signal indicative of an orientation of the second component, a means for determining a reference relative orientation between the first component and the second component based on signals generated by the means for determining an orientation of the first component and the means for determining an orientation of the second component, and a means for determining whether the orientation of the first and second components have changed relative to each other based on the reference relative orientation and signals generated by the means for determining an orientation of the first component and the means for determining an orientation of the second component.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic diagram showing an example system comprising tilt sensors that may be used to determine if one or more components of an electronics package have been tampered with.

FIG. 2 is a schematic diagram of an example monitor that may monitor tilt sensors within a system.

FIG. 3 is a schematic block diagram of functional components of an example tilt sensor that may be used in the systems of the present disclosure.

FIG. 4 is a flow diagram showing an example of the flow of data in an example system including a plurality of tilt sensors.

FIG. 5 is a flow diagram illustrating an example method for determining if a system has been tampered with based on the output of a plurality of tilt sensors.

FIG. 6 is a schematic diagram of the example system of FIG. 1, wherein the system has been tampered with.

FIG. 7 is a schematic diagram of the example system of FIG. 1, wherein the system has been reoriented.

FIGS. 8A and 8B are schematic diagrams of another system comprising tilt sensors that may be used to determine if a system has been tampered with.

FIGS. 9A and 9B are schematic diagrams of yet another example system comprising tilt sensors that may be used to determine if a system has been tampered with.

### DETAILED DESCRIPTION

In general, the present disclosure is directed to devices, systems, and methods for determining whether a component of a package has been tampered with. The term “package,” as used herein, may refer to any package, system, structure, collection, compilation, assortment, array, or arrangement of individual components, wherein one or more of the individual components may move with respect to one or more of the other components. The term “component” as used herein may refer to any individual component, part, piece, member, portion, element, constituent, module, device, apparatus, equipment, machine, mechanism, instrument, or contrivance that may form a part of a package. Packages, such as electronics packages, may include components that a manufacturer or customer does not wish to be inspected or handled by unauthorized users. Thus, it may be desirable to detect when a package has been tampered with. Some existing tamper sensors can be expensive, e.g., because of the structure of the sensors and because the sensors must be designed specifically for a particular package such that mass production is impractical. In addition, existing tamper sensors can have known vulnerabilities, which can decrease the effectiveness of the sensors in detecting tampering with the package.

In examples described herein, a system that can be used to detect tampering with at least one component of a package comprises a plurality of tilt sensors, where each tilt sensor is placed to sense the orientation of at least one component of the package. The tilt sensor can generate a signal indicative of the orientation of the at least one package. The relative orientation of a first tilt sensor with respect to at least one other tilt sensor is determined and stored as a reference relative orientation. Thereafter, the output from the tilt sensors can be monitored to determine the relative orientations of the components. If the orientation of one of the tilt sensors is determined to have changed relative to one or more of the other tilt sensors, e.g., by comparing the output of the tilt sensors to the reference relative orientation, the system may determine that at least one of the components has moved relative to the other component, thereby indicating that the package may have been tampered with.

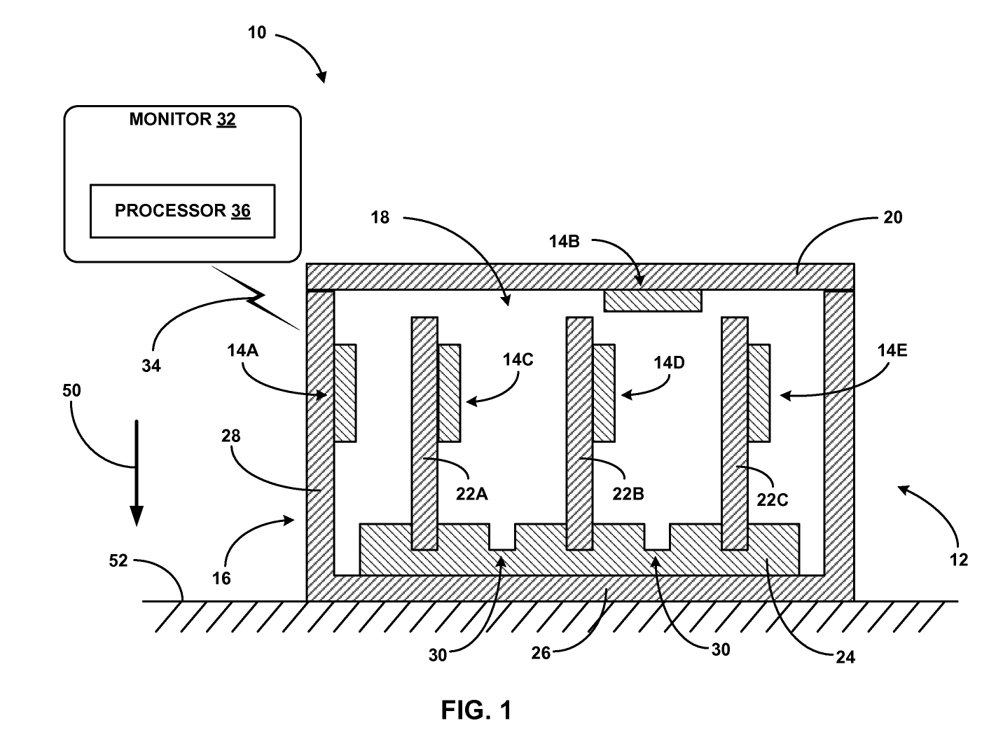

FIG. 1 is a conceptual diagram illustrating an example system 10 comprising a package, such as an electronics package 12, which includes a plurality of tilt sensors 14A-14E (collectively referred to herein as “tilt sensors 14”) that are used to determine if package 12 has been tampered with. Previous systems have used a tilt sensor mounted to a package to determine if the entire package has been tilted. Detecting the overall tilt of the package may be less useful, however, if the package may be moved around because the overall tilt of the package may change even though the package has not been tampered with, but rather has merely been moved during the normal course of use of the package. The plurality of tilt sensors 14 described in the present disclosure, with each tilt sensor 14 being associated with a component of the package, allows for the monitoring of a relative orientation between at least one component compared to at least one other component, which may more easily and robustly determine whether the components have been tampered with by determining whether the relative orientation of one component has changed relative to another component, indicating that the package has been tampered with.

Each tilt sensor 14 is configured to generate an electrical signal corresponding to its orientation, and in turn corresponding to an orientation of a component that the tilt sensor 14 may be adjacent and/or mounted to. In some examples, tilt sensors 14 may comprise inclinometers (sometimes referred to as clinometers, declinometers, tilt sensors, tilt meters, tilt indicators, slope sensors, slope gauges, gradient meters, gradiometers, level sensors, level meters, or pitch and/or roll sensors).

In one example, shown in FIG. 1, package 12 comprises a chassis 16 defining a chamber 18 and a lid 20, which substantially encloses chamber 18 along with chassis 16. In one example, package 12 comprises a plurality of electronics cards 22A, 22B, 22C (collectively referred to herein as “electronics card(s) 22”) mounted within chamber 18. Each electronics card 22 may comprise a plurality of electronic components, devices, or circuitry configured to perform a specific task. Electronics cards 22 may be electrically interconnected and/or connected to other circuitry such that collectively, electronics cards 22 form a functional electronics package 12. In some examples, the configuration of each electronics card 22, or of electronics cards 22 collectively, is proprietary such that the manufacturer or end user may desire to prevent unauthorized tampering or inspection of electronics cards 22.

In the example shown in FIG. 1, electronics cards 22A, 22B, 22C are mounted within a card rack 24 that is mounted to a base 26 of chassis 16. Card rack 24 may comprise a plurality of slots 30, wherein each slot 30 receives and holds one of the electronics cards 22. Each slot 30 may include an electrical connector (not shown) that provides an electrical interconnection between a respective electronics card 22 and another electronics card 22 of package 10, or an electrical connection between a respective electronics card 22 and other circuitry within chamber 18 or outside of chamber 18 (not shown).

In the example shown in FIG. 1, each tilt sensor 14 is associated with a respective component of package 12. A tilt sensor 14 may be considered to be “associated with” a respective component of package 12 when the tilt sensor 14 in question is positioned with respect to the component such that a change in orientation of the component results in a corresponding change to the orientation of the tilt sensor 14. In one example, each tilt sensor 14 may be mounted to a corresponding component so that when the component has a change in orientation, the corresponding tilt sensor 14 has a comparable change in orientation. The term “component” as used herein refers to a structure or part that is a part of package 12, whether it be a structural component (e.g., lid 20) or a functional component (e.g., electronics card 22), wherein each component is a separate physical structure that may be move with respect to the other elements identified as components. In the example shown in FIG. 1, components of package 12 include chassis 16, lid 20 and electronics cards 22. First tilt sensor 14A is mounted to chassis 16, for example, on a side wall 28 of chassis 16, second tilt sensor 14B is mounted to an interior surface (e.g., within chamber 18) of lid 20, and third tilt sensor 14C is mounted to one of the plurality of electronics cards 22. For ease of discussion, chassis 16 is referred to as a first component, lid 20 is referred to as a second component, and electronics card 22A is referred to as a third component. However, other components of system 20 may be the first, second, and third components in other examples. In one example, each electronics card 22 has a respective tilt sensor 14 mounted thereto, such as third tilt sensor 14C mounted to electronics card 22A, a fourth tilt sensor 14D mounted to electronics card 22B, and fifth tilt sensor 14E mounted to electronics card 22C. Although system 10 shown in FIG. 1 comprises five tilt sensors 14, with each component of interest having a single tilt sensor 14 associated therewith, two or more tilt sensors 14 could be associated with each component. Moreover, although system 10 shows a tilt sensor 14 being associated with each component (e.g., chassis 16, lid 20, and electronics cards 22A, 22B, and 22C), each component of package 12 does not require an associated tilt sensor 14. Rather, tilt sensors 14 may be limited only to components where it is desired to be known whether the components are being tampered with. For example, in system 10 of FIG. 1, it may be acceptable to use only a tilt sensor 14A associated with chassis 16 and tilt sensor 14B associated with lid 20 because, in general, most examples of tampering with package 12 would be expected to first involve removal of lid 20 from chassis 16.

When tilt sensors 14A, 14B, 14C, 14D, 14E are mounted to the respective components of package 12, a reference relative orientation that indicates the relative orientation of at least one tilt sensor 14 with respect to at least one other tilt sensor 14 is determined and stored, such as on a memory (described in more detail below). The reference relative orientation may also be referred to as reference relative orientation. After determining and storing the reference relative orientation, the relative orientation between the at least one tilt sensor 14 and the at least one other tilt sensor 14 may be monitored, e.g., via a processor and, based on the reference relative orientation and signals generated by each of the sensors 14 (described in more detail below), it may be determined whether the orientation of the at least one tilt sensor 14 has changed relative to the orientation of the at least one other tilt sensor. A deviation between the monitored relative orientation between the at least one sensor 14 and the at least one other sensor 14 and the recorded reference relative orientation may indicate that one of the components being monitored has moved relative to another component for which the reference relative orientation was determined, which may indicate that package 12 and/or one of its components has been tampered with. This deviation may be referred to herein as becoming “out of sync,” with the recorded reference relative orientation.

The term “reference relative orientation” is used herein to refer to a predetermined orientation of one tilt sensor 14 with respect to the orientation of one or more of the other tilt sensors 14. The reference relative orientation is used as a reference against which a presently determined relative orientation of one or more tilt sensors 14 may be compared in order to determine if one component of package 12 has moved with respect to another component. The components are the components for which the tilt sensors 14 (used to determine the reference relative orientation) indicate an orientation. In some examples, a plurality of reference relative orientations may be determined and stored, with each reference relative orientation corresponding to a unique combination of tilt sensors 14. For example, the relative orientations of first tilt sensor 14A and second tilt sensor 14B as they are arranged in FIG. 1 may correspond to a first reference relative orientation, while the relative orientations of first tilt sensor 14A and third tilt sensor 14C may correspond to a second reference relative orientation. Similarly, the relative orientations of first tilt sensor 14A, second tilt sensor 14B, and fourth tilt sensor 14D may correspond to a third reference relative orientation.

In one example, each reference relative orientation may be determined by positioning corresponding components of package 12 in a desired position, e.g., the position that they will be in during normal operation of package 12 or the position of the components when system 10 is initially assembled, and then determining the orientation of at least one tilt sensor 14 with respect to the orientation of at least one other tilt sensor 14. For example, the positions of package 12 and its components shown in FIG. 1 may represent a desired orientation of tilt sensors 14 that may be recorded and stored as one or more reference relative orientations. In the example of FIG. 1, tilt sensors 14A, 14C, 14D, and 14E have generally vertical orientations, while tilt sensor 14B has a generally horizontal orientation. One reference relative orientation of package 12 may comprise first tilt sensor 14A being generally normal to second tilt sensor 14B, or generally parallel to third tilt sensor 14C, or generally normal to second tilt sensor 14B and generally parallel to third tilt sensor 14C, and so on.

In another example, a reference relative orientation may be determined based on recent or historical orientation determinations of at least one tilt sensor 14 with respect to the orientation of one or more of the other tilt sensors 14. For example, an average orientation of at least one tilt sensor 14 relative to the orientation of at least one other tilt sensors 14 determined for a predetermined period of time preceding a present determination of the orientations of tilt sensors 14 may be used as reference relative orientations. An “average” orientation of one tilt sensor 14 relative to the orientation of at least one other tilt sensors 14 may be determined, for example, by comparing an output value from the first tilt sensor 14 to the output value(s) of each of the other tilt sensors 14 at a plurality of points in time, and then setting the reference relative orientation as the average of the difference in output values between the first tilt sensor 14 and each of the other tilt sensors 14. For example, the relative orientations of at least one tilt sensor 14 compared to at least one other tilt sensor 14 may be determined every 15 seconds, and the reference relative orientation may be determined to be the average of the previous 120 determined orientations corresponding to the preceding 30 minutes. Other parameters of this “moving window” of values could be used, such as a different sampling rate, such as every millisecond, every second, every minute, and so on, or a different total period of time, such as for one minute, 15 minutes, one hour, or one day. The reference relative orientation also does not need to be determined based on a moving window. Rather, in one example, a single, one time window, may be used to determine the reference relative orientation. In another example, a first window may be used to determine a first reference relative orientation that may be used for a first predetermined period of time after which a second window may be used to determine a second reference relative orientation that replaces the first reference relative orientation. For example, a one hour window at a particular time each day may be used to determine the reference relative orientation for the following day.

FIG. 1 shows an electronics package 12 in its operational state, e.g., wherein the components of package 12, chassis 16, lid 20, and electronics cards 22, are in a desired position when electronics package 12 will be operating. In the example of FIG. 1, each electronics card 22 is installed in a respective slot 30, such that each electronics card 22 is electrically connected to an electrical connector and operational, and lid 20 substantially encloses cavity 18 within chassis 16. In one example, system 10 is configured to determine and record a first reference relative orientation between chassis 16 and lid 20, a second reference relative orientation between chassis 16 and first electronics card 22A, a third reference relative orientation between chassis 16 and second electronics card 22B, a fourth reference relative orientation between chassis 16 and third electronics card 22C, a fifth reference relative orientation between lid 20 and first electronics card 22A, a sixth reference relative orientation between lid 20 and second electronics card 22B, a seventh reference relative orientation between lid 20 and third electronics card 22C, an eighth reference relative orientation between first electronics card 22A and second electronics card 22B, a ninth reference relative orientation between first electronics card 22A and third electronics card 22C, and a tenth reference relative orientation between second electronics card 22B and third electronics card 22C. In one example, each reference relative orientation may be determined and recorded by the corresponding components are in a predetermined position, such as when electronics package 12 is known to be in a desired operational state, using tilt sensors 14. One or more of the reference relative orientations described above may be used, either alone or in combination with one or more of the other reference relative orientations, in order to determine whether one of the components has moved with respect to at least one of the other components. For example, the first reference relative orientation and second reference relative orientation may be determined and stored for comparison to later measured relative orientations of tilt sensors 14. Other combinations of the reference relative orientations may be used, such as the first reference relative orientation and third reference relative orientation may be used, or the first reference relative orientation and fifth reference relative orientation. In another example, three or more of the reference relative orientations, such as the first reference relative orientation, the third reference relative orientation, and the fifth reference relative orientation or the second reference relative orientation, the sixth reference relative orientation, and the tenth reference relative orientation may be used to determine if the orientation of at least one component has changed with respect to the orientation of one or more of the other components. In one example, all ten reference relative orientations may be determined and stored to be used to determine whether the orientation of one of the components of package 12 has changed with respect to the orientation of at least one other component.

In one example, system 10 comprises a monitor 32 that communicates with each tilt sensor 14, such as via wireless communications link 34. Monitor 32 may comprise a processor 36 configured to receive a signal from each tilt sensor 14 and determine the reference relative orientation between at least one tilt sensor 14 (and thus the component or components that the at least tilt sensor 14 is mounted to) and at least one other tilt sensor 14. Processor 36 may also monitor the relative orientation between the at least one of the tilt sensors 14 and another tilt sensor 14, and determine whether the relative orientation between the tilt sensors 14 being monitored have deviated from the recorded reference relative orientation for the tilt sensors 14 being monitored. Monitor 32 may be separate from package 12, as shown in FIG. 1, or monitor 32 may be part of the package, for example by being mounted on or within package 12.

Tilt sensors 14 each generate a signal indicative of an orientation of the respective sensor with respect to a frame of reference, for example with respect to gravity 50, which acts in a direction that is generally normal to the ground 52 in the example shown in FIG. 1. In this way, tilt sensors 14 can be used to determine the orientation of the component to which they are mounted. Examples of tilt sensors 14 that may be used in system 10 include inclinometers, clinometers, declinometers, tilt sensors, tilt meters, tilt indicators, slope sensors, slope gauges, gradient meters, gradiometers, level sensors, level meters, and pitch and/or roll sensors. Each tilt sensor 14 may comprise a single-axis tilt sensor (e.g., only measuring tilt in a single axis), a two-axis (also known as “dual-axis”) tilt sensor (e.g., capable of measuring tilt along two axes, i.e., in two dimensions), or a three-axis (also known as “tri-axis”) tilt sensor (e.g., capable of measuring tilt along all three axes in three-dimensional space). Tilt sensors 14 may also comprise a telemetry module for wirelessly communicating with monitor 32 via wireless communications link 34.

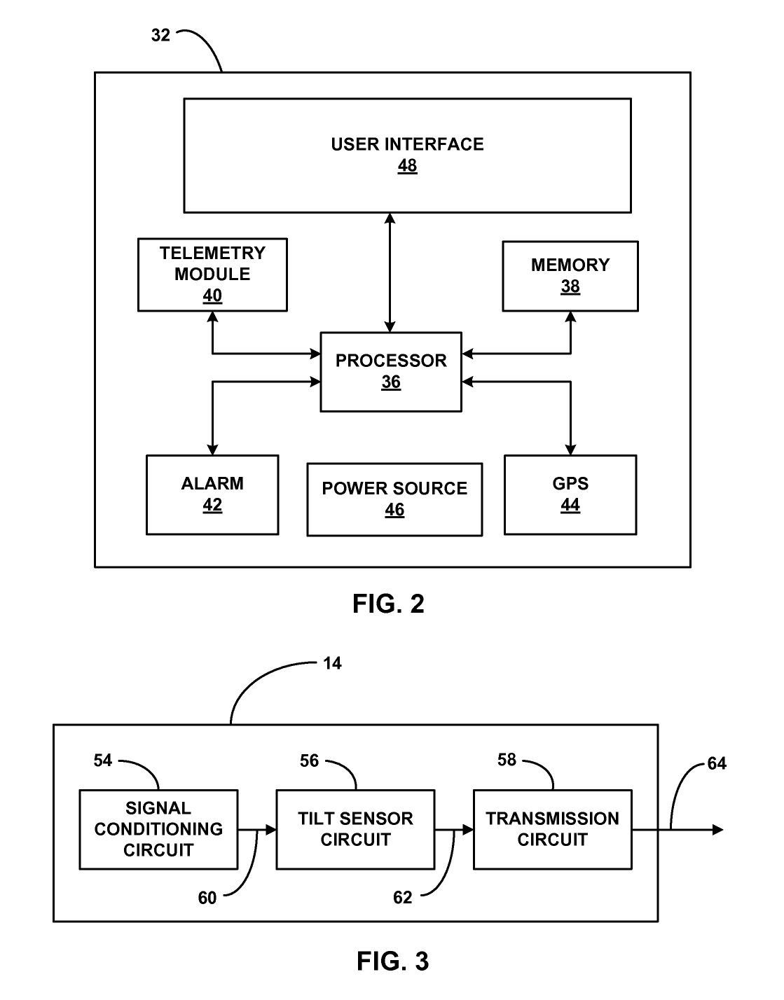

FIG. 2 is a block diagram illustrating various components of an example monitor 32 that may be used to monitor tilt sensors 14 and determine whether one of the tilt sensors 14 is out of sync with a recorded reference relative orientation. In one example, monitor 32 comprises a processor 36, a memory 38, a telemetry module 40, an alarm 42, a Global Positioning System (GPS) module 44, a power source 46, and, in some examples, a user interface 48. In general, processor 36 controls user interface 48, stores and retrieves data to and from memory 38, and controls the transmission of data to and from tilt sensors 14 through telemetry module 40. Processor 36 may also initiate and control alarm 42 and GPS module 44 in certain situations. The functions attributed to processor 36 herein may be implemented, at least in part, in hardware, software, firmware, or any combination thereof. For example, various aspects of the techniques of processor 36 may be implemented within one or more processors, including one or more microprocessors, digital signal processors (DSPs), application-specific integrate circuits (ASICs), field-programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

Monitor 32 communicates with tilt sensors 14. In some examples, each tilt sensor 14 transmits an electrical signal to monitor 32 via a wired or wireless communication technique. Tilt sensors 14 may transmit the signals to monitor 32 at predetermined times, upon interrogation by monitor 32, or at any other suitable time. The frequency at which tilt sensors 14 may transmit signals to monitor 32 may depend on the package and the system application. In some examples, tilt sensors 14 may transmit signals to monitor 32 at a frequency of between about 0.05 millihertz (e.g., once about every 20000 seconds, or about every five hours and thirty three minutes) and about 10 megahertz (e.g., once about every 0.1 microseconds). In one example, each tilt sensor 14 may be configured to send a tilt signal whenever the tilt sensor determines a change in orientation. In such an example, if a first tilt sensor 14 transmits a signal to monitor 32, monitor 32 may be configured to query the other tilt sensors 14 upon receiving the signal from the first tilt sensor 14. Monitor 32 may also be configured to query tilt sensors 14 if monitor 32 has not received a transmission from one or more tilt sensors 14 within a predetermined period of time, for example between about 1 second and about 5 hours. Monitor 32 coordinates the orientation readings of each tilt sensor 14 in order to determine whether one or more of the tilt sensors 14, and consequently one or more of the components on which tilt sensors 14 are mounted, have been tampered with.

Monitor 32 may also determine and store a reference relative orientation of at least one tilt sensor 14 with respect to at least one other tilt sensor 14. As noted above, the reference relative orientation may be determined at a particular point in time, such as when package 12 has been installed in its desired operational state, or a window average may be used. The reference relative orientation may be stored in memory 38. Processor 36 may also be configured to determine whether the relative orientation between at least one tilt sensor 14 and at least one other tilt sensor 14 is out of sync with the relevant recorded reference relative orientation by comparing a relative orientation of the tilt sensors 14 (determined based on the output from the relevant tilt sensors 14) to the relevant recorded reference relative orientation.

In some examples, upon determining that the relative orientation between the at least one tilt sensor 14 and the at least one other tilt sensor 14 is out of sync with the relevant recorded reference relative orientation, processor 36 may generate a notification, such as alarm 42, to alert a user to the out of sync tilt sensors 14, or take another action, such as activate a locator device, such as a GPS device 44, so that monitor 32 may be located. In some examples, processor 36 may also take a defensive action, such as deleting information on memory 38 or transmitting a signal that causes information on electronic cards 22 to be unintelligible (e.g., corrupted or deleting an encryption key).

In some examples, monitor 32 is part of package 12 so that monitor 32 is always proximate to tilt sensors 14. In other examples, monitor 32 may be separate from package 12. In one example, monitor 32 may be located within the same facility or equipment as package 12, such as within the same room or building, or if electronics package 12 is part of a vehicle, such as an airplane, on the same vehicle. In another example, monitor 32 may be remotely located from package 12, for example off-site from package 12, which may be miles away, wherein monitor 32 may communicate with tilt sensors 14 via an intermediate device (not shown) that is part of package 12. In some examples, monitor 32 is associated with only a single package 12 and monitors the tilt sensors 14 of the single package 12, and in other examples monitor 32 may be associated with a plurality of packages and substantially simultaneously monitors the tilt sensors of the plurality of packages.

Memory 38 may store instructions that cause processor 36 to provide various aspects of the functional ascribed to monitor 32 herein. Memory 38 may include any fixed or removable magnetic, optical, or electrical media, such as random-access memory (RAM), read-only memory (ROM), compact disc read-only memory (CD-ROM), magnetic disks, Flash memory, electrically-erasable programmable read-only memory (EEPROM), or the like. Memory 38 may also include a removable memory portion that may be used to provide memory updates or increase memory capacity. Memory 38 may also store the reference relative orientations determined by processor 36 and/or a history of the relative orientations of tilt sensors 14 determined by processor 36. Memory 38 may also store information that controls operation of tilt sensors 14, such as when to transmit or store particular values of the orientation of each tilt sensor 14.

Telemetry module 40 communicates with tilt sensors 14 to transfer data the transfer of data to and from tilt sensors 14, e.g., via wireless communications link 34 (FIG. 1). In some examples, telemetry module 40 communicates automatically with tilt sensors 14 at a scheduled time. In other examples, telemetry module 40 communicates with tilt sensors 14 when predetermined conditions are detected. In one example, telemetry module 40 may communicate with tilt sensors 14 when one or more tilt sensors 14 detect a change in orientation that is transmitted to telemetry module 40, such as when a particular tilt sensor 14 detects a change in orientation that exceeds (e.g., is greater than or equal to) a predetermined threshold tilt change. As another example, telemetry module 40 may communicate with tilt sensors 14 when a change in relative orientation between at least one tilt sensor 14 and at least one other tilt sensor 14 exceeds a predetermined threshold.

Telemetry module 40 may also communicate with tilt sensors 14 at a time determined by a user, who may provide input via user interface 48, e.g., to interrogate sensors 14 to receive the output from sensors 14. To support communication with sensors 14, telemetry module 40 may include appropriate electronic components, such as amplifiers, filters, mixers, encoders, decoders, and the like.

Monitor 32 may communicate wirelessly with tilt sensors 14 using, for example, radio frequency (RF) communication or proximal inductive interaction. This wireless communication is possible through the use of telemetry module 40 which may be coupled to an internal antenna or an external antenna. Monitor 32 may also be configured to communicate with another computing device via wireless communication link 34 through telemetry module 40, or by direct communication through a wired, e.g., network, connection. Examples of local wireless communication techniques that may be employed to facilitate communication between monitor 32 and another computing device include RF communication based on the 802.11 or Bluetooth specification sets, ZigBee communication standards, infrared communication, e.g., based on the IrDA standard, or other standard or proprietary telemetry protocols.

User interface 48 may include a display and one or more input devices that allow monitor 32 to receive input from a user. The display may be, for example, a liquid crystal display (LCD), plasma display, dot matrix display, or touch screen. The input device(s) may include physical buttons, a touch pad, or a touch screen, on monitor 32, or a separate input device, such as a keyboard or mouse, connected to monitor 32, a touch pad, or any other input means capable of receiving input from a user in order to control monitor 32 and/or tilt sensors 14. User interface 48 may also be provided by an additional computing device that communicates with monitor 32.

A user may interact with user interface 48 in order to, for example, indicate that the current relative orientation of at least two tilt sensors 14 should be recorded as a reference relative orientation for the at least two tilt sensors. As another example, the user input received by user interface 48 can indicate the specific sensors 14 for which the relative orientations should be determined and stored in memory 38 (or another memory). In addition, a user can interact with user interface 48 to access data corresponding to the history of tilt sensors 14, such as if and when the relative orientation between two or more tilt sensors 14 may have been out of sync with the recorded reference relative orientations.

Power source 46 delivers operating power to the components of monitor 32. Power source 46 may be a rechargeable battery, such as a lithium ion or nickel metal hydride battery. Other rechargeable or conventional batteries may also be used. In some cases, monitor 32 may be used when coupled to an alternating current (AC) outlet, i.e., AC line power, either directly or via an AC/DC adapter. Power source 46 may include circuitry to monitor power remaining within a battery. In this manner, user interface 48 may provide a current battery level indicator or low battery level indicator when the battery needs to be replaced or recharged. In some cases, power source 46 may be capable of estimating the remaining time of operation using the current battery.

Alarm 44 is configured to provide a notification to a user regarding a condition of tilt sensors 14, such as a notification that indicates that the relative orientation between two or more tilt sensors 14 is out of sync compared to the recorded reference relative orientation. Alarm 44 may be any device that provides a notification to a user, such as via an auditory, visual or somatosensory indication. For example, alarm 44 can be configured to generate and provide an audible alarm that is heard by the user, a vibrational alarm that is felt by the user, a visual alarm that is visible to the user, or a signal sent by monitor 32 to another device, such as an external computing device, wherein the external computing device alerts a user.

GPS module 44 allows a user to locate and/or track monitor 32 in the event that monitor 32 and/or package 12 are tampered with. For example, if processor 36 determines that the relative orientation between two or more tilt sensors 14 is out of sync with the recorded reference relative orientation, processor 36 may be configured to activate GPS module 44 so that the location of monitor 32 can be determined at the time when the dyssynchrony between the tilt sensors 14 and the reference relative orientation was detected, and subsequently thereto. If monitor 32 is associated with package 12, such as by mounting monitor 32 to chassis 16, then GPS module 44 may also allow for locating or tracking package 12. In some examples, package 12 may also comprise its own GPS device (not shown).

In some examples, GPS module 44 is configured to transmit its location to another computing device, either directly from GPS module 44, or via telemetry module 40 or another communications device. Thus, GPS module 44 may be used, for example, if package 12 has been removed from its original operational position without a user's permission, and the user would like to track where package 12 has been taken. GPS module 44 may also be configured to store a log of locations determined by GPS module 44, either within a memory of GPS module 44, within memory 38, or within another memory device. In such a configuration, GPS module 44 may be used to determine where package 12 has been if package 12 is removed and subsequently recovered. In one example, in order to conserve power, processor 36 is configured to activate GPS module 44 only if it is determined that the relative orientation between two or more tilt sensors 14 is out of sync with the reference relative orientation so that GPS module 44 is activated when it may be needed to track package 12 and/or monitor 32.

FIG. 3 is a schematic diagram of example functional components of each tilt sensor 14. Tilt sensors 14 of system 10 may or may not be the same, and the example shown in FIG. 3 is merely one example of a tilt sensor. As shown in the example of FIG. 3, each tilt sensor 14 may comprise a signal conditioning circuit 54, a tilt sensor circuit 56, and a transmission circuit 58. Signal conditioning circuit 54 provides an excitation input signal 60 into tilt sensor circuit 56 so that tilt sensor circuit 56 can produce an output signal 62. Examples of signal conditioning circuits that may be used include single-axis signal conditioners, dual-axis signal conditioners, tri-axis signal conditioners, and AC Wheatstone bridge circuits.

Tilt sensor circuit 56 detects the orientation of tilt sensor 14 with respect to gravity 50. Tilt sensor circuit 56 may comprise a single-axis sensing circuit, a dual-axis sensing circuit, or a tri-axis sensing circuit. Examples of devices that may be used as tilt sensor circuit 56 include, but are not limited to, accelerometers, liquid capacitive inclinometers, electrolytic inclinometers, and gyroscope-type sensors, such as a ring laser gyroscope, or a fiber optic gyroscope. Upon excitation by input signal 60, tilt sensor circuit 56 generates an output signal 62 corresponding to the orientation of tilt sensor 14. In some examples, output signal 62 is an analog signal that corresponds to the orientation or tilt of tilt sensor circuit 56 with respect to gravity 50.

Transmission circuit 58 receives output signal 62 from tilt sensor circuit 56 and transmits a corresponding output signal 64 to monitor 32. Transmission circuit 58 may comprise a signal conditioner that can convert output signal 62 into a type of signal 64 that is usable by monitor 32. In some examples, output signal 62 from tilt sensor circuit 56 comprises an analog electrical signal corresponding to the amount of tilt being experienced by tilt sensor 14, and transmission circuit 58 comprises a signal conditioner for converting the analog output signal 62 into a digital output signal 64 that is usable by processor 36 of monitor 32, such as an analog-to-digital converter (ADC) device. In one example, output signal 62 comprises a relative phase and transmission circuit 58 comprises a phase sensing circuit with a data output suitable for the application. In one example, data is output from the phase sensing circuit in RS-422 differential output. Other output formats may be used, such as transistor-transistor logic (TTL), emitter-coupled logic (ECL), low-voltage positive emitter-coupled logic (LVPECL), complementary metal-oxide-semiconductor (CMOS) logic, and the like.

In one example, signal conditioning circuit 54, tilt sensor circuit 56, and transmission circuit 58 are all comprised in a single device, such as the inclinometers and tilt sensors sold under the SPECTROTILT trade name by Spectron Glass and Electronics Inc. (Hauppauge, N.Y., USA).

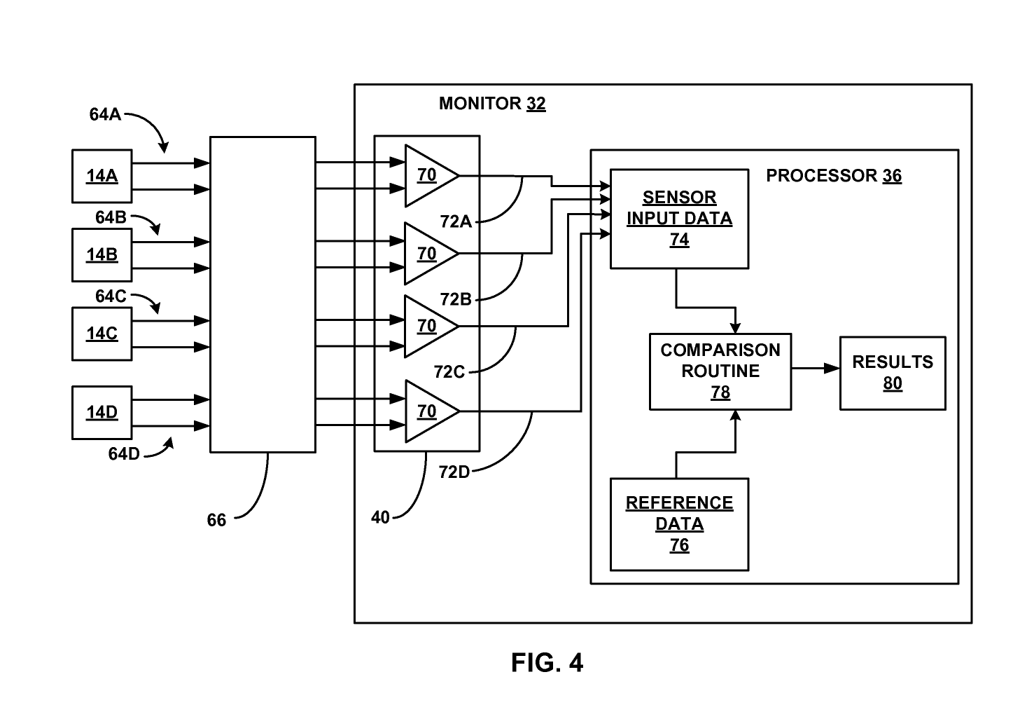

FIG. 4 shows an example flow diagram of the signals from tilt sensors 14. In one example, each tilt sensor 14 produces differential digital output signals 64, e.g., tilt sensor 14A produces output signals 64A, tilt sensor 14B produces output signals 64B, tilt sensor 14C produces output signals 64C, and tilt sensor 14D produces output signals 64D, and so on. Output signals 64 may be terminated in a termination block 66 if termination of signals 64 is necessary. Output signals 64 are then received by telemetry module 40 of monitor 32, where output signals 64 may be amplified by one or more amplifiers 70 to produce amplified signals 72A, 72B, 72C, 72D (collectively referred to herein as “amplified signals 72”). In the example shown in FIG. 4, amplifiers 70 convert the differential digital output signals 64 into single-ended signals 72. Amplifiers 70 may also be separate from telemetry module 40. Amplified signals 72 are sent to processor 36 of monitor 32, where the values of amplified signals 72 are stored in a sensor input data block 74, which may be a portion of memory 38 (FIG. 2). A comparison routine 78 run by processor 36 may determine, for any combination of tilt sensors, the orientation of at least one tilt sensor 14 with respect to at least one other tilt sensor 14 (i.e., the relative orientation between the at least one tilt sensor and the at least one other tilt sensor 14) and compare the relative orientations of the tilt sensors 14 to a set of reference data 76. The comparison generates a result 80, which can indicate, for one or more relative orientation determined, whether the relative orientation of the tilt sensors 14 are in sync with a respective recorded reference relative orientation for the combination of tilt sensors for which the reference relative orientation was determined.

Reference data 76 comprises a recorded reference relative orientation for at least one set of tilt sensors 14, e.g., the relative orientation of at least one tilt sensor 14 with respect to at least one other tilt sensor 14 when package 12 is in its operational state or a window average relative orientation of the at least one tilt sensor 14 with respect to at least one other tilt sensor 14. In some examples, as described above, reference data 76 stores a plurality of reference relative orientations, which can each indicate the reference relative orientation between at least one tilt sensor 14 and at least one other tilt sensor 14 of package 12. Any suitable number of reference relative orientations can be determined and may depend upon the number of tilt sensors 14 in system 10. For example, reference data 76 can store the reference relative orientations for each combination of tilt sensors 14 in system 10 (e.g., a first reference relative orientation for tilt sensor 14A and tilt sensor 14B, a second reference relative orientation for tilt sensor 14A and tilt sensor 14C, a third reference relative orientation for tilt sensor 14A and tilt sensor 14D, a forth reference relative orientation for tilt sensor 14A and tilt sensor 14E, and the like), or reference relative orientations for less than all of the possible combinations of tilt sensors 14 in system 10.

In some examples, reference data 76 may also comprise parameters of deviation that may be acceptable before a determination that at least one tilt sensor 14 is out of sync with at least one other tilt sensor 14 when compared to the recorded reference relative orientation. For example, package 12 may experience vibration such that very slight changes in orientation of one or more tilt sensors 14 may occur. In such cases, reference data 76 may be configured so that if a change in relative orientation between a specific set of tilt sensors 14 is within a range of orientations that would be expected due to vibration, than comparison routine 78 will not indicate that the relative orientation between two or more tilt sensors 14 is out of sync with a reference relative orientation.

In addition, in some examples, reference data 76 may include a time parameter requiring that a relative orientation of at least two tilt sensors 14 must be out of sync with the reference relative orientation for the at least two tilt sensors for a period of time that exceeds the time parameter before comparison routine 78 will indicate that the relative orientation of the tilt sensors 14 is out of sync with the reference relative orientation. Thus, in some examples, if tilt sensors 14 become out of sync but return to being in sync before the expiration of the time parameter, then comparison routine 78 will not indicate that tilt sensors 14 are out of sync. Reference data 76 can include other parameters, such as whether or not a “pause” command has been executed by a user, for example via user interface 48 of monitor 32, which allows the user to move the components of package 12 without a determination that the relative orientation between two or more tilt sensors 14 is out of sync with a reference relative orientation. In some examples, for each parameter, reference data 76 may comprise a range of acceptable values that will not trigger a finding that tilt sensors 14 are in sync.

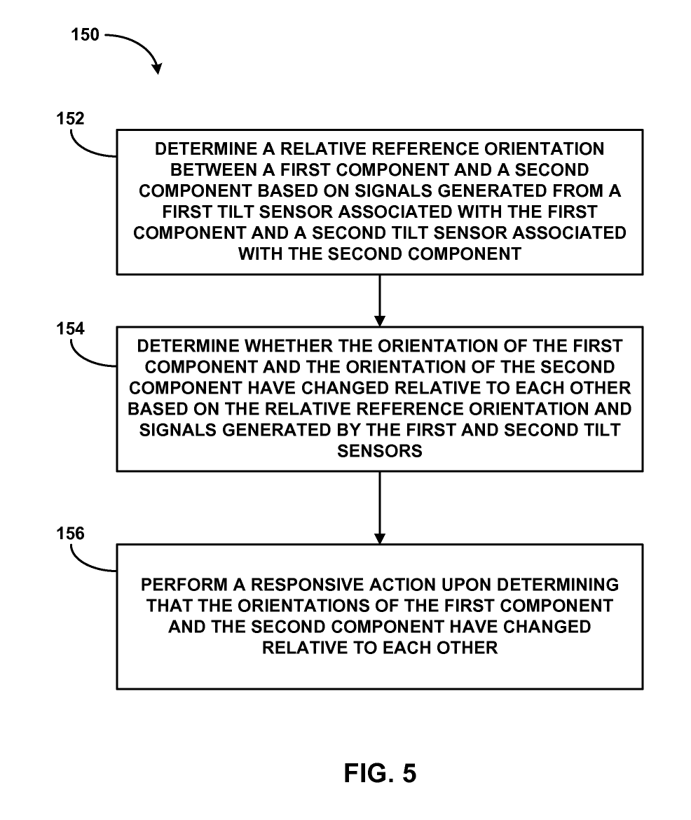

FIG. 5 is a flow diagram of an example method 150 for determining whether a package has been tampered with based on the output of a plurality of tilt sensors. The example method 150 comprises determining a reference relative orientation between a first component and a second component based on signals generated from a first tilt sensor 14A associated with the first component and a second tilt sensor 14B associated with the second component (152). For example, processor 36 of monitor 32 may determine whether the reference relative orientation between a first component, such as chassis 16, and a second component, such as lid 20 or an electronics card 22, based on signals generated from first tilt sensor 14A and second tilt sensor 14B. A tilt sensor 14 may be considered to be “associated with” a respective component of package 12 when the tilt sensor 14 in question is positioned with respect to the component such that a change in orientation of the component results in a corresponding change to the orientation of the tilt sensor 14. In one example method, the first component comprises a chassis 16 of an electronics package 12, and the second component comprises another component of package 12, such as a lid 20 or an electronics card 22A, 22B, 22C. In one example method, first tilt sensor 14A is mounted to the first component so that first tilt sensor 14A and the first component move together and second tilt sensor 14B is mounted to the second component so that second tilt sensor 14B and the second component move together.

In another example method, determining the reference relative orientation (152) comprises determining the reference relative orientation between the first component, the second component, and a third component of package 12 based on signals generated from the first tilt sensor 14A associated with the first component, signals generated from the second tilt sensor 14B associated with the second component (as described above), and signals generated from a third tilt sensor 14C associated with a third component. Determining the reference relative orientation (152) may also comprise determining a plurality of reference relative orientations, e.g. for multiple combinations of tilt sensors 14 and components (e.g., a first reference relative orientation for tilt sensor 14A and tilt sensor 14B, a second reference relative orientation for tilt sensor 14A and tilt sensor 14C, a third reference relative orientation for tilt sensor 14A and tilt sensor 14D, a forth reference relative orientation for tilt sensor 14A and tilt sensor 14E, and the like). Determining the reference relative orientation (152) may comprise using the signals of more than three tilt sensors 14 associated with more than three components. In one example, determining the reference relative orientation (152) is based on signals generated by a plurality of tilt sensors 14, wherein each tilt sensor 14 is mounted to a separate component of package 12, such as tilt sensor 14A mounted to chassis 16, tilt sensor 14B mounted to lid 20, tilt sensor 14C mounted to electronics card 22A, tilt sensor 14D mounted to electronics card 22B, and tilt sensor 14E mounted to electronics card 22C.

In one example, each tilt sensor 14 senses its orientation with respect to a reference, for example with reference to gravity 50 (FIG. 1). In some examples, in order to determine relative orientations between sensors 14, monitor 32 may determine the relative orientation of each tilt sensor 14 with respect to the reference 50 and then determine the relative orientation of at least one tilt sensor 14A with respect to at least one other tilt sensor 14B, 14C, 14D, 14E. Monitor 32 may repeat this determination for another tilt sensor 14, e.g., tilt sensor 14B, with respect to at least one other tilt sensor 14C, 14D, 14E.

For example, as shown in FIG. 1, tilt sensor 14A mounted to chassis 16 has a generally vertical orientation, e.g., generally parallel to gravity 50, as do tilt sensors 14C, 14D, and 14E mounted to electronics cards 22A, 22B, and 22C, respectively, while tilt sensor 14B has a generally horizontal orientation, e.g., generally normal to gravity 50, that is substantially normal to each of tilt sensors 14A, 14C, 14D, and 14D. The orientation of tilt sensor 14A and at least one of the other tilt sensors 14B, 14C, 14D, 14E may be transmitted to monitor 32, such as via a wireless communications link 34. Processor 36 may then determine the relative orientation of at least one tilt sensor 14A with respect to at least one other tilt sensor 14B, 14C, 14D, 14E and record the determined relative orientation as a reference relative orientation, for example on a memory 38 within monitor 32 (FIG. 3) or on a separate memory device. Thus, for example, the relative orientations of tilt sensors 14A, 14B, 14C, 14D, and 14E as shown in FIG. 1 may be recorded as the recorded reference relative orientation for system 10.

After determining the reference relative orientation, method 150 may comprise determining whether the orientation of the first component and second component have changed relative to each other based on the reference relative orientation and signals generated by the first tilt sensor 14A and the second tilt sensor 14B (154). For example, processor 36 of monitor 32 may determine whether the orientations of a first component, such as chassis 16, and a second component, such as lid 20 or an electronics card 22, have changed relative to each other based on the reference relative orientation and signals generated by first tilt sensor 14A and second tilt sensor 14B. If determining the reference relative orientation (152) comprises determining the relative orientations of the first component, second component, and third component, as described above, then determining whether the orientations of the components have changed (154) may comprise determining whether the orientation of at least one of the first component, the second component, and the third component has changed relative to the orientation of another of the first component, the second component, or the third component based on the reference relative orientation and signals generated by first tilt sensor 14A, second tilt sensor 14B, and third tilt sensor 14C. For example, processor 36 (FIG. 1) of monitor 32 can determine, based on signals generated by sensors 14A, 14B, 14C, whether an orientation of a first component has changed relative to at least one of the second and third components, whether an orientation of the second component has changed relative to at least one of the first and third components, or whether an orientation of the third component has changed relative to at least one of the first and second components.

Determining whether the orientations of the components have changed (154) may comprise monitoring tilt sensors 14 over time, such as via processor 36 through telemetry module 44, in order to receive signals from tilt sensors 14 indicative of the orientations of the components. In one example, orientation signals are substantially continuously transmitted between tilt sensors 14 and monitor 32, such as every millisecond, every second, or any other suitable frequency. Processor 36 may then compare the received orientation signals from a particular point in time in order to determine if the relative orientation of at least one of the tilt sensors 14 with respect to at least one other tilt sensor 14 at the particular point in time has changed based on the reference relative orientation.

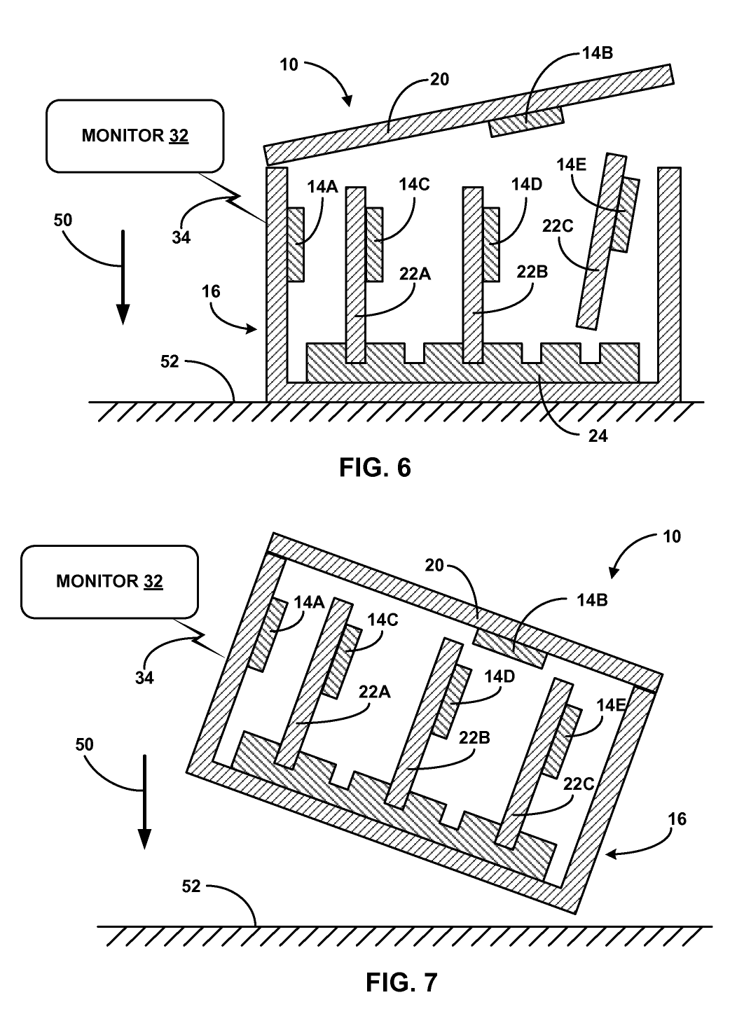

Processor 36 may be configured to monitor the relative orientations of tilt sensors 14. Processor 36 may be further configured to determine whether the relative orientation between at least one tilt sensor 14A and at least one other tilt sensor 14B, 14C, 14D, 14E is out of sync with the recorded reference relative orientation shown in FIG. 1. For example, as shown in FIG. 6, lid 20 has been opened and one of the electronics cards 22C has been removed from card rack 24 and is being removed from package 12. In such a case, tilt sensor 14B mounted to lid 20 has been tilted about 15° counterclockwise with respect to the generally horizontal orientation shown in FIG. 1 and tilt sensor 14E mounted to electronics card 22C has been tilted about 10° clockwise with respect to the generally vertical orientation shown in FIG. 1, while the remaining tilt sensors 14A, 14B, and 14C remain in their original, generally vertical orientation. Thus, for example, processor 36 may determine that tilt sensor 14B is no longer generally normal to tilt sensor 14A so that the relative orientations of tilt sensors 14A and 14B are no longer in sync with a recorded reference relative orientation between tilt sensors 14A and 14B. Similarly, for example, processor 36 may determine that tilt sensor 14E is no longer generally parallel to tilt sensor 14A so that the relative orientations of tilt sensors 14A and 14E are no longer in sync with a recorded reference relative orientation between tilt sensors 14A and 14E.

As described above, a plurality of reference relative orientations for a plurality of combinations of tilt sensors 14 may be stored and used to determine whether the relative orientation between two or more tilt sensors 14 is out of sync with a reference relative orientation (e.g., a first reference relative orientation for tilt sensor 14A and tilt sensor 14B, a second reference relative orientation for tilt sensor 14A and tilt sensor 14C, a third reference relative orientation for tilt sensor 14A and tilt sensor 14D, a forth reference relative orientation for tilt sensor 14A and tilt sensor 14E, and the like). The use of a plurality of reference relative orientations may provide for redundancy in the monitoring of package 12 and an increased likelihood of determining whether package 12 has been tampered with. For example, if a reference relative orientation was determined and stored only for tilt sensors 14A and 14C, then the scenario shown in FIG. 6 would not be recognized as involving tampering because the relative orientations of tilt sensors 14A and 14C do not change. But, if reference relative orientations are also determined and stored for other combinations, such as for example tilt sensors 14A and 14B or tilt sensors 14A and 14E, than system 10 would recognize that package 12 has been tampered with, for example by determining that the relative orientation of tilt sensor 14A and tilt sensor 14E is out of sync with respect to the recorded relative orientation between tilt sensors 14A and 14E.

In some examples, processor 36 may also be configured to determine that at least one tilt sensor 14 is out of sync with respect to the gravity reference 50, even if the relative orientations of the at least one tilt sensor 14 is in sync with the at least one other tilt sensor or sensors 14. For example, FIG. 7 shows an example wherein chassis 16, lid 20, and electronics cards 22 have the same relative orientation with respect to each other as in FIG. 1 so that the relative orientation, for example, between tilt sensors 14A and 14B, are still in sync when compared to the relative orientations of the recorded reference relative orientation, but wherein package 12 has been picked up and tipped such that the orientation of each tilt sensor 14 relative to gravity 50 has changed in the same way. For example, in FIG. 7 the orientation of each tilt sensor 14 has been tilted about 40° in a clockwise direction, e.g., such that tilt sensors 14A, 14C, 14D, and 14D are now oriented at about 40° clockwise from gravity 50 while tilt sensor 14B, which had been normal to gravity 50, is now at about 50° counterclockwise from gravity 50. Processor 36 may be configured such that it recognizes when the orientation of all tilt sensors 14 with respect to gravity 50 have changed, even if the relative orientations of tilt sensors 14 with respect to each other is in sync with the recorded reference relative orientation.

In some examples, method 150 further includes performing a responsive action upon determining that the orientations of the first component and the second component have changed relative to each other based on the reference relative orientation and signals generated by first tilt sensor 14A and the second tilt sensor 14B (156). For example, upon determining that the orientations of the first component and the second component have changed relative to each other based on the reference relative orientation and signals generated by first tilt sensor 14A and the second tilt sensor 14B, processor 36 can generate a notification, such as by activating alarm 42 or another notification device, activate a locator device, such as GPS module 44 or GPS device 102, erase information from a memory, such as memory 38, or transmit a signal that causes information on at least one of the components to be unintelligible, such as monitor 32 sending a signal to one or more electronics cards 22 that cause information stored on electronics cards 22 to become corrupted or causes a decryption key stored by system 10 to be deleted. The responsive action (156) may also comprise initiating damage or destruction to one or more components of the package 12, such as processor 36 generating a signal that activates a destruction device to damage or destroy one or more of the electronics cards 22. The responsive action (156) may also comprise processor 36 storing information relating to the event, for example in a memory 38 of monitor 32 (FIG. 3), such as the time at which it was determined that the tilt sensors 14 are out of sync compared to the recorded reference relative orientation, which component or components were determined to be out of sync, whether the components were returned to being in sync, and if so the time at which the component(s) were returned to being in sync. Other types of information may be stored depending on the system application.

In some examples, method 150 may also comprise, before determining the reference relative orientation (152) mounting first tilt sensor 14A on the first component and mounting second tilt sensor 14B on the second component. In one example, “mounting” as used herein, may mean attaching or adhering tilt sensors 14 to their respective components so that the component and the tilt sensor 14 move together.

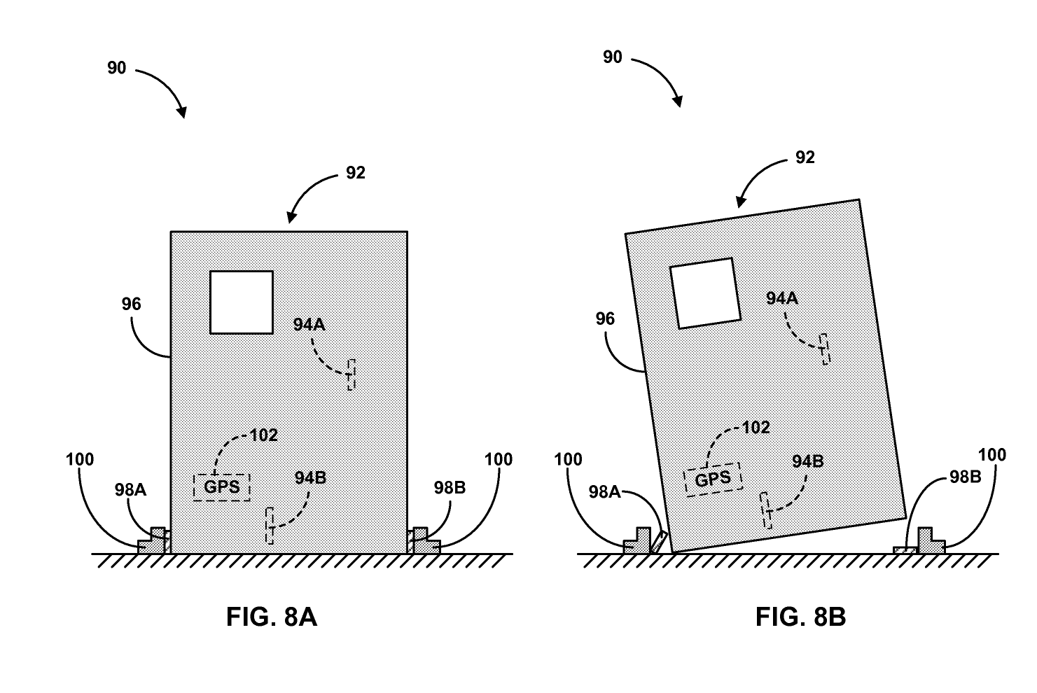

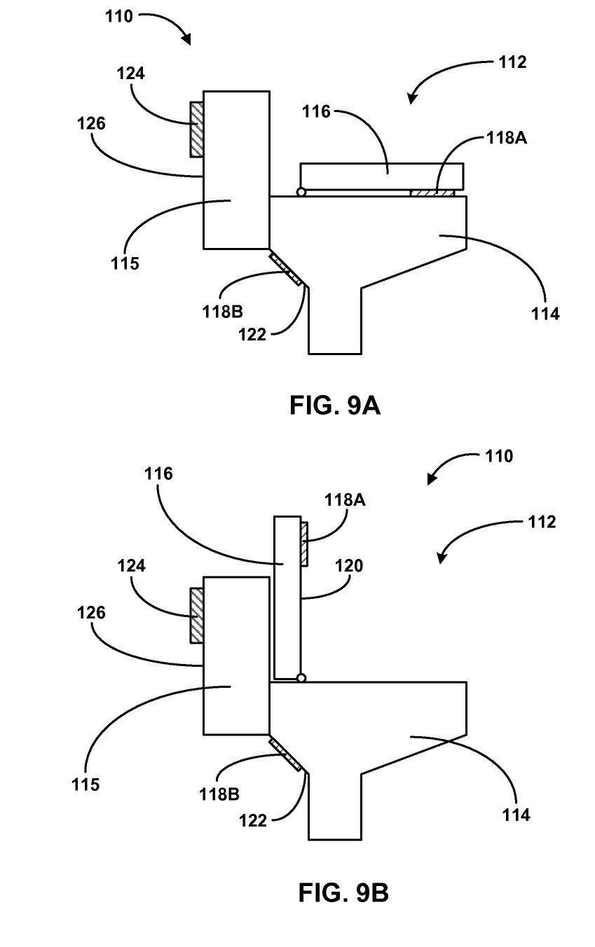

Although the present disclosure has described a system 10 for determining whether an electronics package 12 has been tampered with, a plurality of tilt sensors similar to tilt sensors 14 may be used for detection of tampering of other systems as well. The concepts of the present disclosure may be used with any system wherein it is desired to know whether one or more components have moved with respect to other components of the system. FIGS. 8A, 8B, 9A, and 9B show additional systems that may be used with the concepts of the present disclosure.

FIGS. 8A and 8B show a system 90 comprising an automatic teller machine (ATM) 92 that may be used by a customer to withdraw cash from a bank account. ATM 92 may comprise one or more internal tilt sensors 94A, 94B that are included within an outer housing 96 of ATM 92. System 90 may also comprise one or more external tilt sensors 98A, 98B that are placed outside housing 96, for example between ATM 92 and hardware 100 that is used to secure ATM 92 to a location. In some examples, external tilt sensors 98A, 98B are placed adjacent to housing 96 but are not mounted (e.g., attached) to ATM 92, while internal tilt sensors 94A, 94B are mounted within housing 96 so that if ATM 92 moves, internal tilt sensors 94A, 94B will also move in synchrony with outer housing 96 of ATM 92. While tilt sensors 98A, 98B may move as a result of movement of ATM 92, tilt sensors 98A, 98B move independently of outer housing 96 of ATM 92 such that external tilt sensors 98A, 98B will not move in synchrony with outer housing 96 of ATM 92.

When ATM 92 is installed at its desired location, for example as shown in FIG. 8A, a relative orientation of one of tilt sensors 94A, 94B with respect to at least one tilt sensor 98A, 98B may be determined and stored as a reference relative orientation, such as via a processor of a monitor device similar to monitor 32 described above with respect to FIGS. 1-6. As described above, any suitable number of reference relative orientations may be determined and may depend upon the number of tilt sensors 94A, 94B, 98A, 98B in system 10. For example, a reference relative orientation may be determined and stored for each combination of tilt sensors 94A, 94B, 98A, 98B in system 90 (e.g., a first reference relative orientation for tilt sensor 94A and tilt sensor 94B, a second reference relative orientation for tilt sensor 94A and tilt sensor 98A, a third reference relative orientation for tilt sensor 94B and tilt sensor 98A, a forth reference relative orientation for tilt sensor 94B and tilt sensor 98A, and a fifth reference relative orientation for tilt sensor 98A and tilt sensor 98B), or reference relative orientations for less than all of the possible combinations of tilt sensors 94A, 94B, 98A, 98B in system 90.

If someone attempts to remove ATM 92, than one or both of external tilt sensors 98A, 98B may be moved (e.g., due to the placement against housing 96 of ATM 92, which is subsequently moved), such that one or both external tilt sensors 98A, 98B become out of sync with one or both internal tilt sensors 94A, 94B as compared to the recorded reference relative orientation. FIG. 8B illustrates a configuration in which the relative orientations between tilt sensors 94A, 94B and tilt sensors 98A, 98B are out of sync with the relevant reference relative orientations.

In some examples, ATM 92 comprises a locator device, such as a GPS device 102, that may be activated when it is determined that the relative orientations of tilt sensors 94A, 94B, 98A, 98B are not in sync with the recorded reference relative orientation(s). In some examples, GPS device 102 is not activated until it is determined that the at least one tilt sensor 94A, 94B is out of sync with at least one tilt sensor 98A, 98B compared to the recorded reference relative orientation in order to save power. GPS device 102 may comprise a communications device (not shown) that can transmit the location of ATM 92 so that ATM 92 may be tracked and recovered, and can be similar to GPS 44 described with respect to FIG. 2.

FIGS. 9A and 9B show another system 110 that includes a plurality of tilt sensors that can be used to detect tampering with components of system 110. System 110 comprises a toilet 112 comprising a bowl 114, a tank 115, and a seat 116. Seat 116 can be moved from a closed position (FIG. 9A) to an open position (FIG. 9B). A first tilt sensor 118A may be mounted to seat 116, for example on a bottom surface 120 of seat 116. A second tilt sensor 118B may be mounted to another part of toilet 112 that does not move when seat 116 is moved from the closed position to the open position and vice versa, for example second tilt sensor 118B may be mounted to a bottom surface 122 of bowl 114. In other examples, second tilt sensor 118B may be mounted to other components of toilet 112, such as tank 115, so long as second tilt sensor 118B remains substantially stationary when seat 116 moves between the closed position and the open position.

System 110 may also comprise a monitor 124 that communicates with tilt sensors 118A, 118B, such as through a wireless communications link, in order to determine the relative orientation of first tilt sensor 118A with respect to second tilt sensor 118B. Monitor 124 may be mounted to toilet 112, such as on a back surface 126 of tank 115, or monitor 124 may be located remotely from toilet 112, such as in a different room of the same building that toilet 112 is in, or at an off-site monitoring facility. Monitor 124 may comprise a processor that is configured to determine and record a reference relative orientation of first tilt sensor 118A with respect to second tilt sensor 118B, such as when seat 116 is in the closed position as shown in FIG. 9A.

The processor may also be configured to determine whether tilt sensor 118A has become out of sync with tilt sensor 118B compared to the recorded reference relative orientation. For example, if a user lifts seat 116 into the open position, as shown in FIG. 9B, the processor may determine that the relative orientation of tilt sensor 118A with respect to tilt sensor 118B is no longer in sync with the recorded reference relative orientations. The processor may then be configured to activate a notification, such as an audible alarm, upon detecting that the relative orientation between tilt sensor 118A and tilt sensor 118B has changed compared to the recorded reference relative orientation. In some examples, the notification may be activated immediately after determining the relative orientation between tilt sensor 118A and tilt sensor 118B has changed or after other parameters have been satisfied, such as the passage of a predetermined period of time, or upon initiation of another action by the user, such as a flushing of toilet 112 or without seat 116 being returned to the closed position. As an example, the processor may be configured to generate the notification if seat 116 is not returned to the closed position within a predetermined period of time.

Other types of systems of varying scale may be employed using the techniques of the present disclosure. For example, the “package” of a system may comprise an entire aircraft, wherein each individual electronic component, mechanical component, or piece of cargo of interest may include a tilt sensor mounted thereto in order to determine if a relative orientation of at least two components of interest has become out of sync with respect to a reference relative orientation that was determined when the at least two components of interest were in the orientations of the desired operational state of the package. Other examples that may be employed include a gyroscope and a chassis, a power supply and a chassis, a power supply and an electronics card, and the like.

Functions executed by monitor 32, processor 36 or any other components described herein may be implemented, at least in part, by hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in electronics included in monitor 32 or another device. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, functionality ascribed to processor 36 and other components described above, devices and techniques may be embodied as instructions on a computer-readable medium such as RAM, ROM, NVRAM, EEPROM, FLASH memory, magnetic data storage media, optical data storage media, or the like. The instructions may be executed to support one or more aspects of the functionality described in this disclosure. The computer-readable medium may be nontransitory.

Various embodiments of the invention have been described. These and other embodiments are within the scope of the following claims.

1. A method comprising:
determining with a processor a reference relative orientation between a first component and a second component based on signals generated by a first tilt sensor mounted on the first component and a second tilt sensor mounted on a second component; and
after determining the reference relative orientation, determining with the processor whether an orientation of the first and second components have changed relative to each other based on the reference relative orientation and signals generated by the first and second tilt sensors.

2. The method of claim 1, further comprising:
before determining the reference relative orientation, mounting the first tilt sensor on the first component and mounting the second tilt sensor on the second component;

3. The method of claim 1, wherein the output of the first tilt sensor provides an indication of the orientation of the first component with respect to a reference and the output of the second tilt sensor provides an indication of the orientation of the second component with respect to the reference.

4. The method of claim 3, wherein the reference is gravity.

5. The method of claim 1, wherein the first component and second component are part of a common electronics package, and wherein the first component of the package comprises a chassis of the electronics package.

6. The method of claim 5, wherein the second component of the package comprises at least one of an electronics card within a chamber of the electronics package or a lid of the electronics package.

7. The method of claim 1, wherein determining the reference relative orientation comprises determining the reference relative orientation between the first component, the second component, and a third component based on signals generated by the first tilt sensor associated with the first component, the second tilt sensor associated with the second component, and a third tilt sensor associated with the third component, the method further comprising determining whether the orientation of at least one of the first component, the second component, or the third component has changed relative to the orientation of another of the first component, the second component or the third component based on the reference relative orientation and signals generated by the first tilt sensor, the second tilt sensor, and the third tilt sensor.

8. The method of claim 1, further comprising:
determining that the orientations of the first component and the second component have changed relative to each other based on the reference relative orientation and signals generated by the first tilt sensor and the second tilt sensor; and
performing a responsive action upon determining that the orientations of the first component and the second component have changed relative to each other.

9. The method of claim 8, wherein the responsive action comprises at least one of generating a notification, activating a locator device, erasing a memory of a package comprising the first and second components, or transmitting a signal that causes information on at least one of the first component or the second component to be unintelligible.

10. A system comprising:
a first component and a second component;
a first tilt sensor that generates a signal indicative of an orientation of the first component;
a second tilt sensor that generates a signal indicative of an orientation of the second component; and
a processor configured to:
determine a reference relative orientation between the first component and the second component based on signals generated by the first tilt sensor and the second tilt sensor; and
after determining the reference relative orientation, determine whether the orientation of the first and second components have changed relative to each other based on the reference relative orientation and signals generated by the first and second tilt sensors.

11. The system of claim 10, wherein the first tilt sensor is mounted to the first component and the second tilt sensor is mounted to the second component.

12. The system of claim 10, wherein the processor is further configured to synchronize the first tilt sensor and the second tilt sensor with respect to a reference.

13. The system of claim 12, wherein the reference is gravity.

14. The system of claim 10, further comprising an electronics package comprising the first and second components, wherein the first component of the package comprises a chassis of the electronics package.

15. The system of claim 14, wherein the second component of the package comprises at least one of an electronics card within a chamber of the electronics package or a lid of the electronics package.

16. The system of claim 10, further comprising a third component and a third tilt sensor that generates a signal indicative of an orientation of the third component, wherein the processor is configured to:
determine the reference relative orientation between the first component, the second component, and the third component based on signals generated by the first tilt sensor, the second tilt sensor, and the third tilt sensor; and
determine whether the orientation of at least one of the first component, the second component, or the third component has changed relative to the orientation of another of the first component, the second component, or the third component based on the reference relative orientation and signals generated by the first tilt sensor, the second tilt sensor, and the third tilt sensor.

17. The system of claim 16, further comprising an electronics package, wherein the first component of the package comprises a chassis of the electronics package, the chassis defining a chamber therein, the second component of the package comprises a lid enclosing the chamber, and the third component of the package comprises an electronics card mounted within the chamber.

18. The system of claim 10, further comprising an alarm, wherein the processor is further configured to initiate the alarm upon determining that the orientations of the first component and the second component have changed relative to each other based on the reference relative orientation and signals generated by the first tilt sensor and the second tilt sensor.

19. The system of claim 10, further comprising a global positioning system device, wherein the processor is further configured to activate the global positioning system device upon determining that the orientations of the first component and the second component have changed relative to each other based on the reference relative orientation and signals generated by the first tilt sensor and the second tilt sensor.

20. A system comprising:
a first component and a second component;
a means for determining an orientation of the first component, the means for determining an orientation of the first component generating a signal indicative of an orientation of the first component;
a means for determining an orientation of the second component, the means for determining an orientation of the second component generating a signal indicative of an orientation of the second component;
a means for determining a reference relative orientation between the first component and the second component based on signals generated by the means for determining an orientation of the first component and the means for determining an orientation of the second component; and
a means for determining whether the orientation of the first and second components have changed relative to each other based on the reference relative orientation and signals generated by the means for determining an orientation of the first component and the means for determining an orientation of the second component.
